(19) United States
(12) Patent Application Publication
(10) Pub. No.: US 2026/0091528 A1
(43) Pub. Date: Apr. 2, 2026

(54) PUNCH AND DIE APPARATUS FOR MANUFACTURING SECONDARY BATTERY AND ELECTRODE PLATE KNOCKOUT DEVICE

(71) Applicant: SAMSUNG SDI CO., LTD., Yongin-si (KR)

(72) Inventors: Gwang Tae AN, Yongin-si (KR); Tae Yun SEOK, Yongin-si (KR); Young Jin JANG, Yongin-si (KR)

(21) Appl. No.: 19/342,983

(22) Filed: Sep. 29, 2025

(30) Foreign Application Priority Data
Sep. 30, 2024 (KR) 10-2024-0133288

(51) Int. Cl. B26F 1/14; H01M 10/0585; H01M 10/0587

(52) U.S. Cl. CPC B26F 1/14; H01M 10/0585; H01M 10/0587

(57) ABSTRACT

The present disclosure relates to a punch and die apparatus for manufacturing a secondary battery and an electrode plate knockout device. The punch and die apparatus includes a lower die that supports an electrode plate and has one or more scrap discharge holes, an upper die positioned above the lower die and including a punch corresponding to each of the scrap discharge holes, and a knockout device including a guide body partially protruding toward the scrap discharge hole and configured to provide a support force upon being fixed to the lower die, a knockout block supported by the guide body to vertically move and supports the electrode plate via a reaction force corresponding to a downward pressure of the punch to a bottom surface of the electrode plate when the punch punches the electrode plate, and an elastic force providing part elastically supporting the knockout block.

### CROSS-REFERENCE TO RELATED APPLICATION

The present application claims priority to and the benefit under 35 U.S.C § 119(a)-(d) of Korean Patent Application No. 10-2024-0133288, filed in the Korean Intellectual Property Office on Sep. 30, 2024, the entire disclosure of which is incorporated herein by reference.

### BACKGROUND

### 1. Field

The present disclosure relates to a punch and die apparatus for manufacturing a secondary battery. More specifically, the present disclosure relates to a punch and die apparatus for manufacturing a secondary battery, which does not cause a shear defect when an electrode plate is punched, and an electrode plate knockout device.

### 2. Description of Related Art

While primary batteries are not designed to be (re)charged, secondary (also known as rechargeable) batteries are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

The positive electrode plate or the negative electrode plate may be manufactured through a coating process, a roll pressing process, a slitting process, or a notching process. In the notching process, an electrode plate is manufactured by cutting unnecessary portions of a substrate using a shear die and forming an electrode tab. The die is installed in a pair of punches and dies forming a bottom and a tab of the substrate, and a press facility for operating them.

However, in the punch and die process, a front end portion of the electrode plate may be torn during punch processing. Such a tearing substantially degrades precision of the electrode plate.

The information disclosed in this Background section is for enhancement of understanding of the background of the present disclosure. The section may contain information that does not constitute related (or prior) art.

### SUMMARY

The present disclosure is directed to providing a punch and die apparatus for manufacturing a secondary battery, which provides a result having accurate dimensions without causing punching defects by improving a shear support force of a base part by holding and compressing a coated part of an electrode plate when the electrode plate is punched, and an electrode plate knockout device.

Embodiments of the present disclosure provide a punch and die apparatus for manufacturing a secondary battery, the punch and die apparatus including a lower die that supports an electrode plate that is an object to be processed and has one or more scrap discharge holes, an upper die installed above the lower die and provided with a punch corresponding to the scrap discharge outlet hole, and a knockout device including a guide body that partially protrudes to the scrap discharge hole and provides a support force while fixed to the lower die, a knockout block that is supported by the guide body to vertically move and supports the electrode plate to apply a reaction force corresponding to a downward pressure of a punch to a bottom surface of the electrode plate when the punch punches the electrode plate, and an elastic force providing part elastically supporting the knockout block.

Embodiments of the present disclosure provide an apparatus including: a lower die configured to support an electrode plate, the lower die including a scrap discharge hole; an upper die positioned above the lower die, and the upper die including a punch corresponding to the scrap discharge hole; and a knockout device including: a guide body partially protruding toward the scrap discharge hole and configured to provide a support force upon being fixed to the lower die; a knockout block supported by the guide body, the knockout block configured to vertically move and configured to support the electrode plate via a reaction force corresponding to a downward pressure of the punch to a bottom surface of the electrode plate upon the punch punching the electrode plate; and an elastic force providing part configured to elastically support the knockout block.

In an embodiment, the guide body includes: a die fixing part mounted on the lower die; and a block support part formed as a single component with the die fixing part, the block support part located inside the scrap discharge hole and configured to support the knockout block.

In an embodiment, the electrode plate includes a coated part in which a substrate is coated with an active material and an uncoated part in which the substrate is exposed, wherein the knockout block includes an electrode plate support part configured to be in contact with a bottom surface of the coated part and configured to apply the reaction force to the coated part.

In an embodiment, the knockout block further includes a slider part configured to slide while in contact with an inner wall surface of the scrap discharge hole.

In an embodiment, the knockout block is located above the block support part, and wherein the elastic force providing part includes a block support spring located between the block support part and the knockout block.

In an embodiment, the block support part includes a vertical extension hole vertically passing through the block support part, and wherein the apparatus further includes a vertical movement guide part configured to be coupled to the knockout block upon passing through the vertical extension hole and configured to guide a vertical movement of the knockout block.

In an embodiment, the vertical movement guide part is a guide bolt passing upward through the vertical extension hole, and wherein an upper end of the guide bolt is coupled to the knockout block.

In an embodiment, the apparatus further includes a liner fixed to an inner circumferential surface of the vertical extension hole.

In an embodiment, an inner circumferential surface of the vertical extension hole includes a heat dissipation passage.

In an embodiment, the apparatus includes: a vertical extension hole; a restriction space located under the vertical extension hole, and a female screw hole located under the restriction space, wherein the vertical extension hole, the restriction space, and the female screw hold are positioned along a vertical line in the block support part, and wherein the block support part includes: a lifting rod having a lower end fitted into the restriction space and an upper end coupled to the knockout block, the lifting rod configured to be vertically movable; a support bolt coupled to the female screw hole; and a rod spring located between the support bolt and the lifting rod, the rod spring configured to elastically support the lifting rod are included in the block support part.

Embodiments of the present disclosure provide an electrode plate knockout device including a guide body installed inside a scrap discharge hole of a punch and die apparatus for manufacturing a secondary battery, the punch and die apparatus including a lower die that supports an electrode plate and has one or more scrap discharge holes and an upper die installed above the lower die and having a punch corresponding to the scrap discharge hole, the guide body providing a support force, a knockout block that is installed on the guide body, supports the electrode plate when the punch punches the electrode plate, and applies a reaction force corresponding to a downward pressure of the punch to a bottom surface of the electrode plate, and an elastic force providing part elastically supporting the knockout block.

Embodiments of the present disclosure provide an electrode plate knockout device for an apparatus including a lower die and an upper die, the lower die configured to support an electrode plate, the lower die including a scrap discharge hole, the upper die positioned above the lower die, and the upper die including a punch corresponding to the scrap discharge hole, the electrode plate knockout device including: a guide body partially protruding toward the scrap discharge hole and configured to provide a support force upon being fixed to the lower die; a knockout block supported by the guide body, the knockout block configured to vertically move and configured to support the electrode plate via a reaction force corresponding to a downward pressure of the punch to a bottom surface of the electrode plate upon the punch punching the electrode plate; and an elastic force providing part configured to elastically support the knockout block.

In an embodiment, the guide body include: a die fixing part mounted on the lower die; and a block support part formed as a single component with the die fixing part, the block support part located inside the scrap discharge hole and configured to support the knockout block.

In an embodiment, the electrode plate includes a coated part in which a substrate is coated with an active material and an uncoated part in which the substrate is exposed, wherein the knockout block includes an electrode plate support part configured to be in contact with a bottom surface of the coated part and configured to apply the reaction force to the coated part.

In an embodiment, the knockout block further includes a slider part configured to slide while in contact with an inner wall surface of the scrap discharge hole.

In an embodiment, the knockout block is located above the block support part, and wherein the elastic force providing part includes a block support spring located between the block support part and the knockout block.

In an embodiment, the block support part includes a vertical extension hole vertically passing through the block support part, and wherein the electrode plate knockout device further includes a vertical movement guide part configured to be coupled to the knockout block upon passing through the vertical extension hole and configured to guide a vertical movement of the knockout block.

In an embodiment, the vertical movement guide part is a guide bolt passing upward through the vertical extension hole, and wherein an upper end of the guide bolt is coupled to the knockout block.

In an embodiment, the electrode plate knockout device further includes a liner fixed to an inner circumferential surface of the vertical extension hole.

In an embodiment, an inner circumferential surface of the vertical extension hole includes a heat dissipation passage.

In an embodiment, the electrode plate knockout device further includes: a vertical extension hole; a restriction space located under the vertical extension hole', and a female screw hole located under the restriction space, wherein the vertical extension hole, the restriction space, and the female screw hold are positioned along a vertical line in the block support part, and wherein the block support part includes: a lifting rod having a lower end fitted into the restriction space and an upper end coupled to the knockout block, the lifting rod configured to be vertically movable; a support bolt coupled to the female screw hole; and a rod spring located between the support bolt and the lifting rod, the rod spring configured to elastically support the lifting rod are included in the block support part.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is schematic view showing an electrode assembly of a secondary battery according to embodiments of the present disclosure;

FIG. 2 shows an interior of a pouch-type battery to which the electrode assembly of FIG. 1 is applied according to embodiments of the present disclosure;

FIG. 3 is a cross-sectional view of a cylindrical battery according to embodiments of the present disclosure;

FIG. 4 is a perspective view showing an exterior of a prismatic battery according to embodiments of the present disclosure;

FIG. 5 is a cross-sectional view along line A-A of FIG. 4 according to embodiments of the present disclosure;

FIG. 6 shows an electrode plate notching process using a punch and die apparatus according to embodiments of the present disclosure;

FIG. 7 shows an overall structure of a punch and die apparatus for manufacturing a secondary battery according to embodiments of the present disclosure;

FIG. 8 is a partial cross-sectional view showing a configuration of an electrode plate knockout device shown in FIG. 7 according to embodiments of the present disclosure;

FIG. 9 is a cutaway exploded perspective view of the electrode plate knockout device shown in FIG. 7 according to embodiments of the present disclosure;

FIG. 10 is a side view of the electrode plate knockout device according to embodiments of the present disclosure;

FIG. 11 shows an electrode plate being punched using the electrode plate knockout device according to embodiments of the present disclosure;

FIG. 12 shows an electrode plate being punched using the electrode plate knockout device according to embodiments of the present disclosure;

FIG. 13 shows an electrode plate being punched using the electrode plate knockout device according to embodiments of the present disclosure;

FIG. 14 shows a modification of the electrode plate knockout device according to embodiments of the present disclosure;

FIG. 15 is a cross-sectional view along line C-C of FIG. 14 according to embodiments of the present disclosure;

FIG. 16 is a cross-sectional view showing a modification of a guide body shown in FIG. 9 according to embodiments of the present disclosure; and

FIG. 17 shows a modification of the electrode plate knockout device according to embodiments of the present disclosure.

FIG. 18 shows a modification of the electrode plate knockout device according to embodiments of the present disclosure.

### DETAILED DESCRIPTION

Hereinafter, embodiments of the present disclosure will be described, in detail, with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her invention in the best way. The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

The embodiments described herein can be explained with reference to cross-sectional views and/or plan views as example views of the present disclosure. In the figures, dimensions of the various elements, layers, etc. may be exaggerated for clarity of illustration. Thus, regions presented as an example in the drawings have general properties, and shapes of the exemplified areas can be used to illustrate a specific shape of a device region. Therefore, this should not be construed as limited to the scope of the present disclosure. Although the terms such as first, second, and third are used to describe various components in various embodiments herein, the components should not be limited to these terms. These terms are used only to distinguish one component from another component. Embodiments described and exemplified herein include complementary embodiments thereof. The same reference numerals designate the same elements.

References to two compared elements, features, etc. as being “the same” may mean that they are “substantially the same. ” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

Further, it will be understood that if an element is referred to as being “on,” “connected to,” or “coupled to” another element, it may be directly on, connected, or coupled to the other element, but still another element may be “interposed” between the elements or the elements may be “connected to” or “coupled to” each other through still another embodiment.

As used herein, the term “and/or” includes any and all combinations of one or more of the associated listed items. Further, the use of “may” if describing embodiments of the present disclosure relates to “one or more embodiments of the present disclosure. ” Expressions, such as “at least one of” and “any one of,” if preceding a list of elements, modify the entire list of elements and do not modify the individual elements of the list.

Throughout the specification, if “A and/or B” is stated, it means A, B or A and B, unless otherwise stated. When “C to D” is stated, it means C or more and D or less, unless otherwise specified.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

The terminology used herein is for the purpose of describing embodiments of the present disclosure and is not intended to limit the present disclosure.

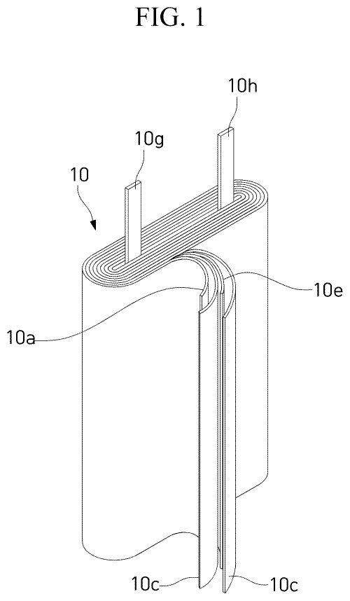

FIG. 1 is a schematic view of an electrode assembly 10 including an electrode plate 10a, 10e manufactured using a punch and die apparatus for manufacturing a secondary battery according to embodiments of the present disclosure.

An electrode assembly 10 may be formed by winding or stacking a stack of a first electrode plate 10a, a separator 10c, and a second electrode plate 10e, each of which are formed as thin plates or films. In an embodiment, the electrode assembly 10 may be a wound stack, and a winding axis may be parallel to the longitudinal direction of a case (not illustrated).

In an embodiment, the electrode assembly 10 may be a stacked type. The shape of the electrode assembly 10 is not limited in the present disclosure. In an embodiment, the electrode assembly 10 may be a Z-stack electrode assembly in which a first electrode plate and a second electrode plate are inserted into opposite sides of a separator, which is then bent into a Z-stack.

In an embodiment, one or more electrode assemblies 10 may be stacked (e.g., arranged) such that longitudinal sides of the electrode assemblies 10 are adjacent to each other and accommodated in a case. The number of electrode assemblies in a case is not limited in the present disclosure. The first electrode plate 10a of the electrode assembly 10 may be configured as a negative electrode and the second electrode plate 10e may be configured as a positive electrode, and vice versa.

The first electrode plate 10a may be formed by applying a first electrode active material, such as graphite or carbon, onto a first substrate formed of a metal foil including copper, a copper alloy, nickel, or a nickel alloy. The first electrode plate 10a may include a first electrode tab 10g (e.g., a first uncoated portion), which is a region to which the first electrode active material is not applied. The first electrode tab 10g may be connected to an external first terminal (not illustrated). In some embodiments, when the first electrode plate 10a is manufactured, the first electrode tab 10g may be formed by being cut in advance to protrude to or protrude from one side of the electrode assembly 10. In some embodiments, the first electrode tab 10g may protrude to or protrude from one side of the electrode assembly 10 farther than or beyond the separator 10c without being separately cut.

The second electrode plate 10e may be formed by applying (e.g., coating or depositing) a second electrode active material, such as a transition metal oxide, onto a substrate formed of a metal foil including aluminum or an aluminum alloy. The second electrode plate 10e may include a second electrode tab 10h (e.g., a second uncoated portion), which is a region to which the second electrode active material is not applied. The second electrode tab 10h may be connected to an external second terminal (not illustrated). In some embodiments, the second electrode tab 10h may be formed by being cut in advance to protrude to or protrude from the other side (e.g., the opposite side) of the electrode assembly 10 when the second electrode plate 10e is manufactured. In some embodiments, the second electrode plate 10e may protrude to or protrude from the other side of the electrode assembly farther than or beyond the separator 12 without being separately cut.

The separator 10c prevents a short-circuit between the first electrode plate 10a and the second electrode plate 10e while allowing migration of lithium ions therebetween. The separator 10c may include a polyethylene film, a polypropylene film, a polyethylene-polypropylene film, or the like.

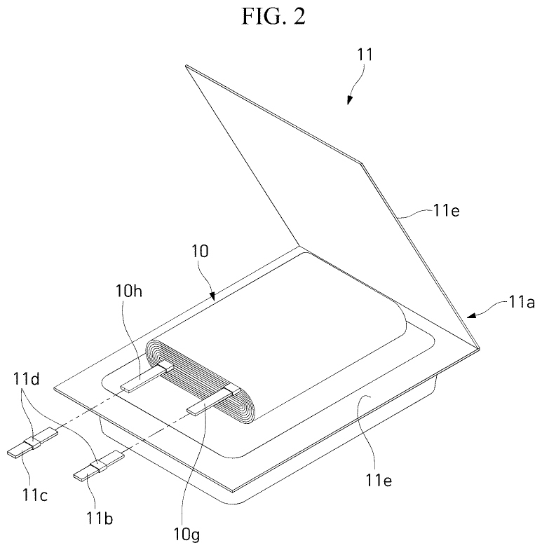

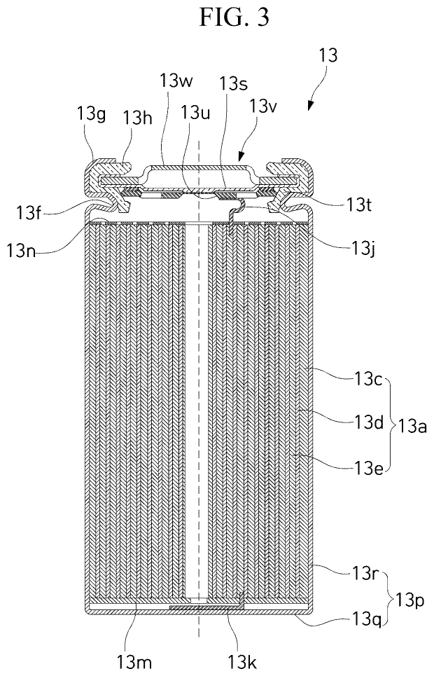

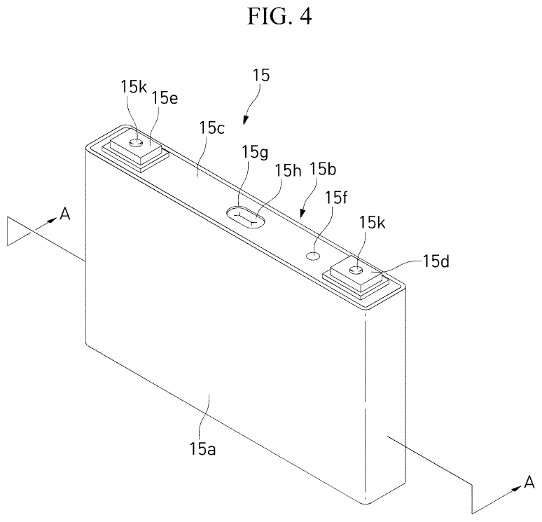

In some embodiments, the electrode assembly 10 may be accommodated in a case along with an electrolyte. In a pouch-type secondary battery, an electrode assembly 10 may be accommodated in a pouch made of flexible material (see, e.g., FIG. 2). In a cylindrical or prismatic secondary battery, an electrode assembly 10 may be accommodated in a cylindrical or prismatic metal casing (see, e.g., FIGS. 3 and 4).

The positive electrode active material may include a compound capable of reversibly intercalating/deintercalating lithium (e.g., a lithiated intercalation compound). In an embodiment, the positive electrode active material may include at least one of a composite oxide of lithium and a metal including cobalt, manganese, nickel, or combinations thereof.

The composite oxide may include a lithium transition metal composite oxide, such as a lithium nickel-based oxide, a lithium cobalt-based oxide, a lithium manganese-based oxide, a lithium iron phosphate-based compound, a cobalt-free nickel-manganese-based oxide, or a combination thereof.

In an embodiment, the composite oxide may include a compound represented by any one of the following formulas: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{3-f}Fe₂(PO₄)₃ (0≤f≤2); and LiₐFePO₄ (0.90≤a≤1.8) where A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer positioned on the substrate. The positive electrode active material layer may include a positive electrode active material and may further include a binder and/or a conductive material.

The positive electrode active material may include about 90 wt % to about 99.5 wt % on the basis of 100 wt % of the positive electrode active material, and about 0.5 wt % to about 5 wt % of a binder, and about 0 wt % to about 5 wt % of a conductive material on the basis of 100 wt % of the positive electrode active material layer.

The substrate may include aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may include a carbon-based negative electrode active material including crystalline carbon, amorphous carbon, or a combination thereof. In an embodiment, the crystalline carbon may include graphite, such as natural graphite or artificial graphite, and the amorphous carbon may include soft carbon, hard carbon, a meso-phase pitch carbide, sintered coke, and the like.

A Si-based negative electrode active material or a Sn-based negative electrode active material may be used as the material capable of being doped and undoped with lithium. The Si-based negative electrode active material may include silicon, a silicon-carbon composite, SiOₓ (0<x<2), a Si-based alloy, or a combination thereof.

The silicon-carbon composite may include a composite of silicon and/or amorphous carbon. According to an embodiment, the silicon-carbon composite may exist in the form of a silicon particle and amorphous carbon coated on the surface of the silicon particle.

The silicon-carbon composite may further include crystalline carbon. In an embodiment, the silicon-carbon composite may include a core including crystalline carbon and silicon particle and an amorphous carbon coating layer on the surface of the core.

A negative electrode for a lithium secondary battery may include a substrate and a negative electrode active material layer positioned on the substrate. The negative electrode active material layer may include a negative electrode active material and may further include a binder and/or a conductive material.

The negative electrode active material layer may include about 90 wt % to about 99 wt % of a negative electrode active material, about 0.5 wt % to about 5 wt % of a binder, and about 0 wt % to about 5 wt % of a conductive material on the basis of 100 wt % of the negative electrode active material layer.

The binder may include a non-aqueous binder, an aqueous binder, a dry binder, or a combination thereof. When an aqueous binder is used as the negative electrode binder, a cellulose-based compound capable of enhancing viscosity may be further included.

The negative electrode substrate may include copper foil, nickel foil, stainless steel foil, titanium foil, nickel foam, copper foam, conductive metal-coated polymer substrate, or combinations thereof.

The electrolyte for a lithium secondary battery may include a non-aqueous organic solvent and/or a lithium salt.

The non-aqueous organic solvent is configured to serve as a medium through which ions involved in the electrochemical reaction of the battery can migrate.

The non-aqueous organic solvent may include a carbonate-based, an ester-based, an ether-based, a ketone-based, an alcohol-based solvent, an aprotic solvent, or combinations thereof.

In an embodiment, when a carbonate-based solvent is used, a mixture of cyclic carbonate and chain carbonate may be used.

Depending on the type of lithium secondary battery, a separator may be present between the positive electrode and the negative electrode. The separator may include polyethylene, polypropylene, polyvinylidene fluoride, or a multilayer film including two or more layers thereof.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles including Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or combinations thereof but is not limited thereto.

The organic material and the inorganic material may be combined into one coating layer or may be in the form of a coating layer including an organic material and a coating layer including an inorganic material where one coating layer is stacked onto the other.

FIG. 2 is a schematic view showing a pouch-type battery 11 to which the electrode assembly 10 of FIG. 1 is applied according to embodiments of the present disclosure.

The pouch-type battery 11 includes an electrode assembly 10 and a pouch 11a that accommodates the electrode assembly 10.

A first electrode tab 10g and a second electrode tab 10h of the electrode assembly 10 may be electrically connected to respective external first terminal lead 11b and second terminal lead 11c by welding. Each of the first terminal lead 11b and the second terminal lead 11c may be attached with a tab film 11d for insulation from the pouch 11a.

The pouch 11a may be sealed by having sealing parts 11e at the edges thereof come into contact with each other while accommodating the electrode assembly 10 therein,. The sealing may be achieved with the tab film 11d interposed between the sealing parts 11e. The sealing parts 11e of the pouch 11a may each include a thermal fusion material that generally has weak adhesion to metal. Thus, the sealing parts 11e may be fused to the pouch 11a by interposing the thin tab film 11d between the sealing parts 21.

FIG. 3 is a cross-sectional view of a cylindrical battery 13 including the electrode plate that may be manufactured using the punch and die apparatus for manufacturing a secondary battery according to embodiments of the present disclosure.

A cylindrical battery 13 may include an electrode assembly 13a, a case 13p accommodating the electrode assembly 13a and the electrolyte, a cap assembly 13v coupled to an opening of the case 13p to seal the case 13p, and an insulating plate 13n positioned between the electrode assembly 13a and the cap assembly 13v inside the case 13p.

The electrode assembly 13a may include a separator 13d, a first electrode 13c, and a second electrode 13e. The separator 13d is interposed between the first electrode 13c and the second electrode 13e and may be wound in a jelly-roll shape.

The first electrode 13c includes a first substrate and a first active material layer on the first substrate. A first lead tab 13j may extend outwardly from a first uncoated portion of the first substrate where the first active material layer is not coated, and the first lead tab 13j may be electrically connected to the cap assembly 13v.

The second electrode 13e includes a second substrate and a second active material layer on the second substrate. A second lead tab 13k may extend outwardly from a second uncoated portion of the second substrate where the second active material layer is not coated, and the second lead tab 13k may be electrically connected to the case 13p. The first lead tab 13j and the second lead tab 13k may extend in opposite directions.

The first electrode 13c may be configured to serve as a positive electrode. In an embodiment, the first substrate may include an aluminum foil, and the first active material layer may include a transition metal oxide. The second electrode 13e may be configured to serve as a negative electrode. In an embodiment, the second substrate may include a copper foil or a nickel foil, and the second active material layer may include graphite.

The separator 13d prevents a short circuit between the first electrode 13c and the second electrode 13e while allowing migration of lithium ions therebetween. The separator 13d may include a polyethylene film, a polypropylene film, a polyethylene-polypropylene film, or the like.

The case 13p accommodates the electrode assembly 13a and the electrolyte, and together with the cap assembly 13v, forms the external appearance of the secondary battery. The case 13p may have a substantially cylindrical body portion 13r and a bottom portion 13q connected to one side of the body portion 13r. A beading part 13f is recessed inwardly against the body portion 13r, and a crimping part 13g is bent inwardly at an open end of the body portion 13r.

The beading part 13f is configured to reduce or prevent any movement of the electrode assembly 13a inside the case 13p and can facilitate seating of a gasket 13h and the cap assembly 13v. The crimping part 13g may firmly fix the cap assembly 13v by pressing the edge of the cap assembly 13v against the gasket 13h. The case 13p may include iron plated with nickel.

The cap assembly 13v may be fixed to the inside of the crimping part 13g via the gasket 13h to seal the case 13p. The cap assembly 13v may include a cap up 13w, a safety vent 13s, a cap down 13t, an insulating member, and a sub plate 13u, but is not limited thereto and may be modified in various ways.

The cap up 13w may be positioned at the uppermost part of the cap assembly 13v. The cap up 13w may include a terminal part that protrudes upwardly and is connected to an external circuit, and an outlet for discharging gas may be arranged around the terminal part.

The safety vent 13s may be located under the cap up 13w. The safety vent 13s may include a protrusion part that protrudes convexly downwardly and connected to the sub plate 13u, and at least one notch (not shown) located around the protrusion part.

When gas is generated due to overcharging or abnormal operation of the secondary battery, the protrusion part is deformed upwardly by the gas pressure and separates from the sub plate 13u while the safety vent 13s is cut along the notch. The cut safety vent 13s may prevent the secondary battery from exploding by allowing the gas to be discharged to the outside of the battery 13.

The cap down 13t may be located below the safety vent 13s. The cap down 13t may have a first opening for exposing the protrusion part of the safety vent 13s and a second opening for gas discharge. The insulating member (not shown) may be positioned between the safety vent 13s and the cap down 13t to insulate the safety vent 13s and the cap down 13t.

The sub plate 13u may be located under the cap down 13t. The sub plate 13u may be fixed to a lower surface of the cap down 13t to block the first opening of the cap down 13t, and the protrusion part of the safety vent 13s may be fixed to the sub plate 13u. The first lead tab 13j, which is drawn out from the electrode assembly 13a, may be fixed to the sub plate 13u. Accordingly, the cap up 13w, the safety vent 13s, the cap down 13t, and the sub plate 13u may be electrically connected to the first electrode 13c of the electrode assembly 13a.

The insulating plate 13n may be positioned to be in contact with the electrode assembly 13a below the beading part 13. The insulating plate 13n may have a tab opening (not shown) through which the first lead tab 13j is drawn out. The cap assembly 13v, which is electrically connected to the first electrode 13c via the first lead tab 13j, is positioned opposite to the electrode assembly 13a via the insulating plate 13n interposed therebetween. The cap assembly 13v may maintain a state of being insulated from the electrode assembly 13a via the insulating plate 13n. The battery 13 may include a second insulating plate 13m for insulating the electrode assembly 13a from the bottom portion 13q of the case 13p.

FIG. 4 is a top perspective view showing an exterior of a prismatic battery 15 including the electrode plate that may be manufactured using the punch and die apparatus for manufacturing a secondary battery according to embodiments of the present disclosure.

A case 15a defines an overall appearance of the prismatic secondary battery, and may include a conductive metal, such as aluminum, aluminum alloy, or nickel-plated steel. The case 15a may provide a space for accommodating an electrode assembly.

A cap assembly 15b may include a cap plate 15c that covers an opening of the case 15a. In an embodiment, the case 15a and the cap plate 15c may include a conductive material. A first terminal 15d and a second terminal 15e may be electrically connected to respective positive and negative electrodes within the case, and may be installed to protrude outward through the cap plate 15c.

The cap plate 15c may be equipped with an electrolyte injection port 15f, a gas discharge hole 15g, and a gas discharge device 15h that may be coupled to the gas discharge hole 15g. The gas discharge device 15h can be open by gas generated inside the battery performing a degassing operation.

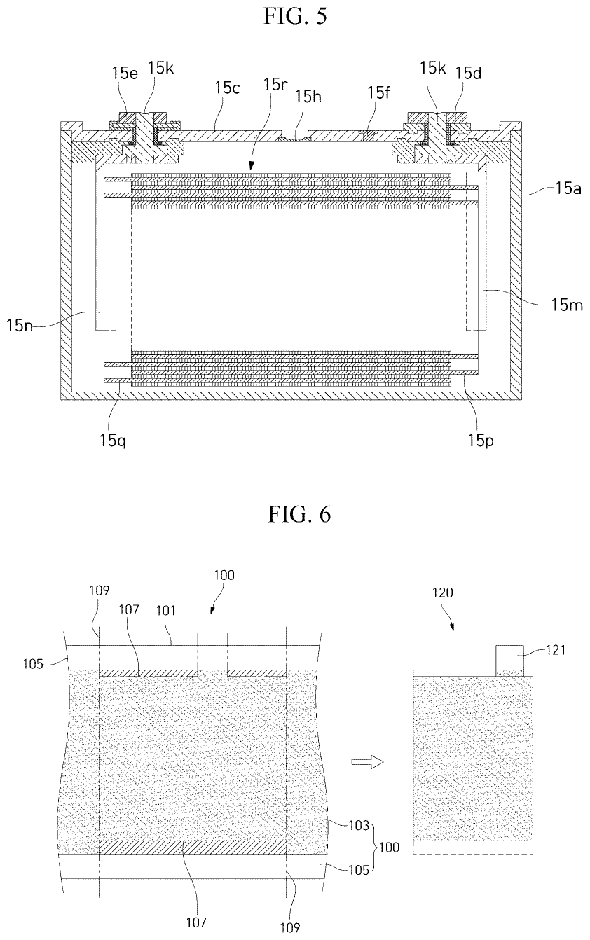

FIG. 5 is a cross-sectional view along line A-A of FIG. 4 and shows an internal configuration of a prismatic battery and a structure of the cap assembly 15b according to embodiments of the present disclosure.

The electrode assembly 15r may be formed by winding or stacking a first electrode plate, a separator, and a second electrode plate, which are formed as thin plates or films. When the electrode assembly 15r is a wound stack (e.g., a jelly roll), a winding axis may be parallel to the longitudinal direction of the case. In an embodiment, the electrode assembly 15r may be a stacked type rather. The shape of the electrode assembly 15r is not limited in the present disclosure.

In an embodiment, the electrode assembly 15r may be a Z-stack electrode assembly in which a first electrode plate and a second electrode plate are inserted into both sides of the separator, which is then bent into a Z-stack. In an embodiment, in the electrode assembly 15r, one or more electrode assemblies may be stacked such that longitudinal sides of the electrode assemblies are adjacent to each other and accommodated in the case. The number of electrode assemblies in the case is not limited in the present disclosure. The first electrode plate of the electrode assembly 15r may be configured as a negative electrode and the second electrode plate may be configured as a positive electrode, and vice versa.

The first electrode plate may be formed by applying a first electrode active material, such as graphite, carbon, or the like, to a first electrode substrate formed of a metal foil, including copper, a copper alloy, nickel, a nickel alloy, or the like. The first electrode plate may include a first electrode tab (e.g., a first uncoated portion) that is a region to which the first electrode active material is not applied. The first electrode tab 15p may act as a current flow path between the first electrode plate and a first current collector 15m. In some embodiments, when the first electrode plate is manufactured, the first electrode tab 15p is formed by being cut in advance to protrude to or protrude from one side of the electrode assembly 15r. In some embodiments, the first electrode tab 15p may protrude to or protrude from one side of the electrode assembly 15r farther than or beyond the separator without being separately cut.

The second electrode plate may be formed by applying a second electrode active material, such as a transition metal oxide, on a substrate formed of a metal foil including aluminum or an aluminum alloy. The second electrode plate may include a second electrode tab 15q (e.g., a second uncoated portion) that is a region to which the second electrode active material is not applied. The second electrode tab 15q may act as a current flow path between the second electrode plate and the second current collector 15n. In some embodiments, the second electrode tab 15q may be formed by being cut in advance to protrude to or protrude from the other side of the electrode assembly when the second electrode plate is manufactured. In some embodiments, the second electrode plate may protrude to or protrude from the other side of the electrode assembly farther than or beyond the separator without being separately cut.

In an embodiment, the first electrode tab 15p and the second electrode tab 15q are located on a right hand side surface and a left hand side surface, respectively, of the electrode assembly 15r. In some embodiments, both the first electrode tab 15p and the second electrode tab 15q may be located on the right hand side surface or the left hand side surface of the electrode assembly 15r together.

The left hand side and the right hand side of the electrode assembly 15r are based on the battery shown in FIG. 3, the left hand side surface refers a surface of a vertical surface of the electrode assembly 15r, to which a second current collector plate 15n is joined, and the right hand side surface is an opposite surface and refers to a surface to which the first current collector plate 15m is joined. The left hand side surface and the right hand side surface of the electrode assembly 15r may be switched when the battery rotates in a left-right direction or a vertical direction.

The separator prevents or substantially reduces instances of a short circuit between the first electrode plate and the second electrode plate while allowing migration of lithium ions therebetween. The separator may include a polyethylene film, a polypropylene film, a polyethylene-polypropylene film, or the like.

In some embodiments, the electrode assembly 15r may be accommodated in the case 15a along with an electrolyte.

In the electrode assembly 15r, the first electrode tabs 15p and the second electrode tabs 15q protruding from the first electrode plate and the second electrode plate, respectively, may be connected to the first current collector plate 15m and the second current collector plate 15n, respectively.

The first current collector plate 15m and the second current collector plate 15n are electrically connected to the first terminal 15d and the second terminal 15e, respectively, through connection members 15k. In some embodiments, the connection members 15k may each have an outer peripheral surface that is threaded, and may be fastened to the first terminal 15d and the second terminal 15e by screwing. However, the present disclosure is not limited thereto. In an embodiment, the connection members 15k may also be coupled to the first terminal 15d and the second terminal 15e by riveting or welding.

FIG. 6 is a schematic view showing a notching process cutting the manufactured electrode plate into a design shape and shows shapes of an electrode plate 100 before notching and an electrode plate 120 after notching according to embodiments of the present disclosure. The electrode plate 100 includes a substrate 101 coated with an active material, has a predetermined width, and is wound in a roll.

The substrate 101 coated with the active material may be cut along a transverse cutting line 109 and cut along another cutting line 107 in the notching process. An uncoated part 105 may be removed and organized during the cutting.

As shown on the right hand side of FIG. 6, the notched electrode plate 120 has an area coated with a positive electrode material or a negative electrode material and a tab 121 including an uncoated area. The tab 121 is a part in which a conductive member such as a current collector or a sub-plate is joined in a subsequent electrode assembly process.

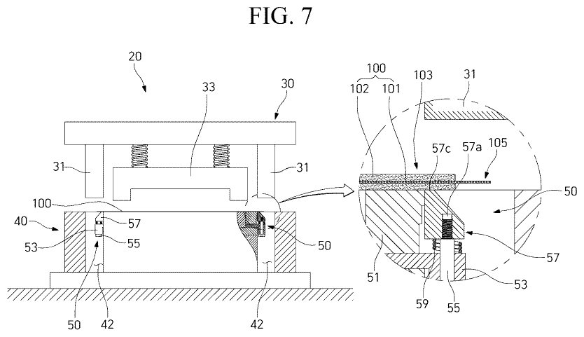

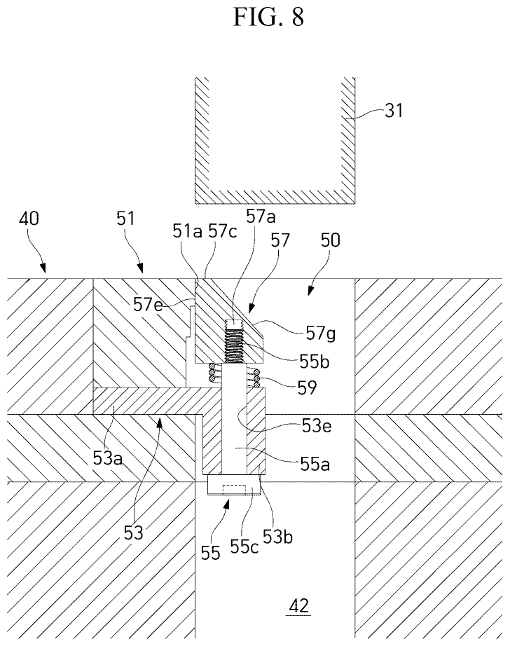

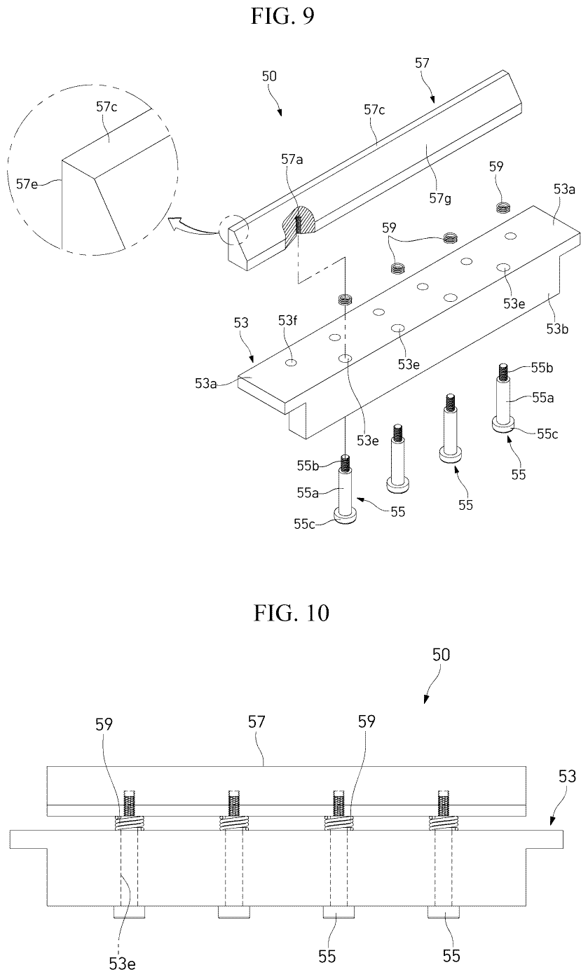

FIG. 7 shows an overall structure of a punch and die apparatus for manufacturing a secondary battery according to embodiments of the present disclosure, FIG. 8 is a partial cross-sectional view showing a configuration of an electrode plate knockout device illustrated in FIG. 7 according to embodiments of the present disclosure, FIG. 9 is a cutaway exploded perspective view of the electrode plate knockout device according to embodiments of the present disclosure, and FIG. 10 is a side view of the electrode plate knockout device according to embodiments of the present disclosure.

In an embodiment, the electrode plate 100 for a secondary battery is punched through a punch and die apparatus 20. In particular, a knockout device 50 is applied to the punch and die apparatus 20.

Referring to FIGS. 6 to 10, the punch and die apparatus 20 for manufacturing a secondary battery is an apparatus where the electrode plate 100 is supplied to and is punched to manufacture a final electrode plate (e.g., 120 in FIG. 6). A basic structure of the electrode plate 100 includes the substrate 101 and an active material 102 coated to the substrate 101. A part coated with the active material 102 is referred to as a coated part 103, and the substrate 101 that is not coated with the active material but exposed is referred to as an uncoated part.

The punch and die apparatus 20 may include a lower die 40, an upper die 30, and a knockout device 50.

The lower die 40 may horizontally support the electrode plate 100 to be notched for a secondary battery. One or more scrap discharge holes 42 may be positioned in the lower die 40. The scrap discharge hole 42 is a passage where scrap generated during the punching (that is, portions removed from the electrode plate 100) is discharged to a lower side. The removed portions may be an area beyond the cutting lines 107 and 109 shown in FIG. 6.

A planar shape of the scrap discharge hole 42 may correspond to a shape of the cutting line 107. The shape of the scrap discharge hole 42 may vary depending on the shape of the electrode plate 120 to be manufactured. Portions to be punched in the electrode plate 100 seated on the lower die 40, that is, portions of the uncoated part 105 and the coated part 103, are placed above the scrap discharge hole 42 for a punch 31 to be lowered.

As shown in FIG. 8, a die 51 may be fixed to an upper end of the scrap discharge hole 42. The die 51 is a partial component of the lower die 40 and may be separated from the lower die 40. The die 51 may fix a guide body 53 and guide a vertical movement of a knockout block 57.

A vertical support surface 51a may be formed on a surface of the die 51 facing the scrap discharge hole 42. The vertical support surface 51a may be in contact with a slider part 57e of the knockout block 57 and may guide a vertical movement of the slider part 57e. The vertical support surface 51a may be perpendicular to a horizontal plane and may guide the vertical movement of the knockout block 57. In some embodiments, an uneven structure having a predetermined cross-sectional shape may be additionally applied to the vertical support surface 51a.

The upper die 30 may be installed above the lower die 40 configured to vertically move and may include one or more punches 31. The punch 31 may be located above the scrap discharge hole 42 in a vertical direction and may correspond to the scrap discharge hole 42. A cross-sectional shape of the punch 31 is substantially the same as a planar shape of an inner space of the scrap discharge hole 42. The punch 31 punches the electrode plate 100 while entering the scrap discharge hole 42.

A stripper 33 is installed on the upper die 30. The stripper 33 may fix the electrode plate 100 when the electrode plate 100 is punched so that the electrode plate 100 may be maintained in an accurate position.

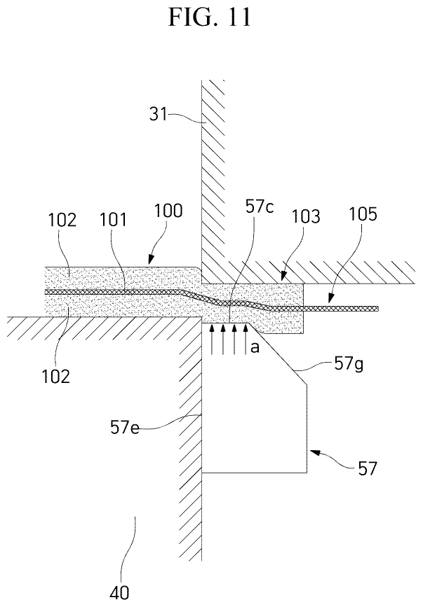

The knockout device 50 may elastically support a bottom surface of a portion punched by the punch 31, that is, a portion removed from the electrode plate 100 at the moment when the electrode plate 100 is punched. In more detail, as shown in FIG. 11, a bottom surface of the coated part 103 to be removed may be elastically supported in a direction of arrow a.

A support force in the direction of arrow a may be a reaction force corresponding to a downward pressure of the punch 31. The reaction force may be an elastic force output from an elastic support part inside the knockout device 50, that is, a block support spring 59. By the action of the knockout device 50, a portion of the electrode plate to be removed is compressed by the punch 31 and the knockout block 57, and a thickness thereof reduces according to the compression. As the thickness reduces, a shear support force of a base part is improved, thus accurate dimensions may be provided without causing a punching defect.

The knockout device 50 includes the guide body 53, the knockout block 57, and an elastic providing part (not shown).

The guide body 53 may partially protrude toward the scrap discharge hole 42 while being fixed to the lower die 40 and provide a support force. The guide body 53 may include a die fixing part 53a and a block support part 53b.

The die fixing part 53a is a part that is fixedly engaged with the lower die 40. As shown in FIG. 8, the die fixing part 53a may be fixed to a lower portion of the die 51. The die fixing part 53a may have a predetermined thickness and may have a plurality of through-holes 53f. The through-hole 53f may be a hole through which a fixing screw may pass. The guide body 53 may be fixed to the lower die 40 using the screw.

The block support part 53b may be formed as a single component with the die fixing part 53a and may support the knockout block 57 while protruding toward the scrap discharge hole 42. A plurality of vertical extension holes 53e may be formed in the block support part 53b. The vertical extension hole 53e is a vertical passage having a predetermined inner diameter and vertically passes through the block support part 53b. A guide bolt 55 is fitted into the vertical extension hole 53e as a vertical movement guide part for guiding the vertical movement of the knockout block 57.

The guide bolt 55 is a shaft-type bolt that passes upward through the vertical extension hole 53e and may have a bolt head 55c, a vertical shaft part 55a, and a male screw part 55b. The vertical shaft part 55a may be a round bar-shaped member and may move only in the vertical direction without shaking in a left-right direction while accommodated in the vertical extension hole 53e.

The male screw part 55b may be coupled to a screw part 57a formed in the knockout block 57. The bolt head 55c may be located under the block support part 53b and prevent the knockout block 57 from being dislocated to the upper side.

The knockout block 57 may be supported on the guide body 53 to vertically move and may support the electrode plate and apply a reaction force corresponding to the downward pressure of the punch 31 to a bottom surface of the electrode plate, and more particularly, to the bottom surface of the coated part 103, when the punch 31 punches the electrode plate.

The knockout block 57 may move in the vertical direction on the guide body 53. As shown in FIG. 9, the knockout block 57 may be a rod-shaped member extending horizontally and linearly. The plurality of coupling screw parts 57a may be formed on a bottom surface of the knockout block 57. The coupling screw part 57a may be coupled to the male screw part 55b of the guide bolt 55.

The knockout block 57 may include an electrode plate support part 57c, a slider part 57e, and a discharge inclined surface part 57g.

The electrode plate support part 57c may be a flat part formed at an upper end of the knockout block 57 and having a predetermined width. As shown in FIG. 11, the electrode plate support part 57c is a part that may be in close contact with the bottom surface of the coated part 103 and may press and support the coated part 103 in the direction of arrow a. The electrode plate support part 57c may be in close contact with the bottom surface of the coated part 103 and may apply a reaction force corresponding to the downward pressure of the punch 31 to the coated part 103.

The slider part 57e is a part that is in contact with the vertical support surface 51a. The slider part 57e slides in the vertical direction while in contact with an inner wall surface of the scrap discharge hole 42, that is, the vertical support surface 51a of the die 51. The slider part 57e may vertically move while in contact with the vertical support surface 51a. The slider part 57e may not be spaced apart from the vertical support surface 51a while the knockout block 57 vertically moves.

The discharge inclined surface part 57g is an inclined surface that guides discharge of the punched scrap. The scrap discharged from the electrode plate 100 may be smoothly discharged by the discharge inclined surface part 57g.

An elastic force providing part (not shown) may be configured to elastically support the knockout block 57 in the upward direction. The elastic force providing part may include a block support spring 59. The block support spring 59 is a coil-type spring installed between the block support part 53b and the knockout block 57. The block support spring 59 may elastically support the knockout block 57 upward while surrounding the vertical shaft part 55a of the guide bolt 55.

FIGS. 11 to 13 sequentially show an electrode plate being punched using the electrode plate knockout device 50 according to embodiments of the present disclosure. For convenience, only the knockout block 57 is illustrated among components of the knockout device 50.

FIG. 11 is a view in which the punch 31 is lowered and punching is initiated. The portion to be removed may be a portion outside the cutting line 107 shown in FIG. 6.

Referring to FIG. 11, the punch 31 is lowered while pressing an upper surface of the coated part 103. The knockout block 57 supports the bottom surface of the coated part 103 in the direction of arrow a. The portion to be removed interposed between the punch 31 and the knockout block 57 is compressed in a thickness direction.

As the knockout block 57 is applied, the portion of the electrode plate 100 to be removed may become thinner than other portions and may be punched while maintaining this thinner state. Because the portion to be removed is thinly compressed, a shear support force of the substrate 101 may be improved, sliding may not occur, and a precise shear surface may be obtained. In an embodiment, a torn mark or a fine strand, thinner than a thread, does not form.

When the knockout block is not applied, the portion to be removed is sheared while sagging downward, and thus the shear surface after the punching may not be vertical. In an embodiment, the shear surface may not be perpendicular to the horizontal plane, may be inclined in a diagonal direction, thus may not result in a clean cut.

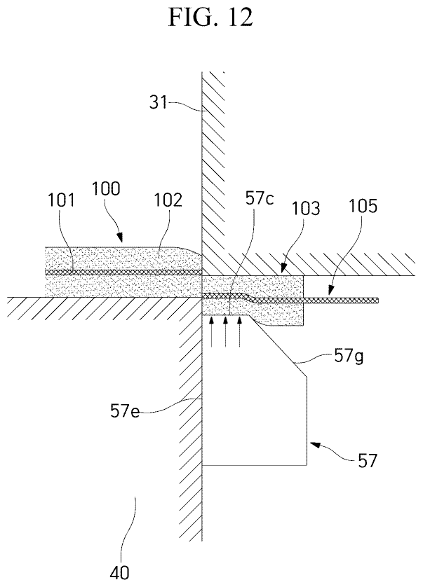

FIG. 12 shows a moment at which the punch 31 is further lowered and the substrate 101 and the active material 102 are separated from each other. Because the knockout block 57 continuously supports the bottom surface of the portion to be removed, the portion to be removed does not sag downward, and thus a precise shear can be performed.

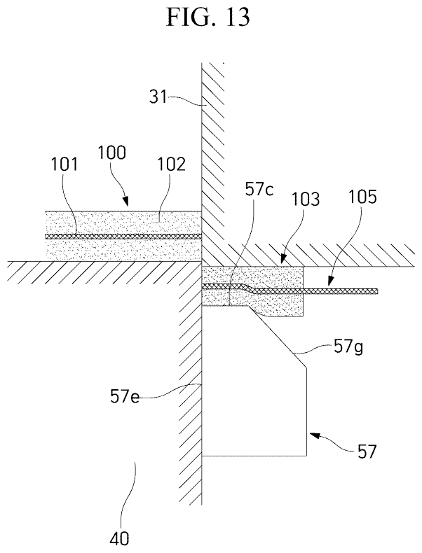

FIG. 13 shows the portion to be removed being completely sheared. When the punch 31 is raised after the portion to be removed is completely sheared, the removed scrap falls downward due to gravity, and the punch 31 and the knockout block 57 are raised and return to their original locations.

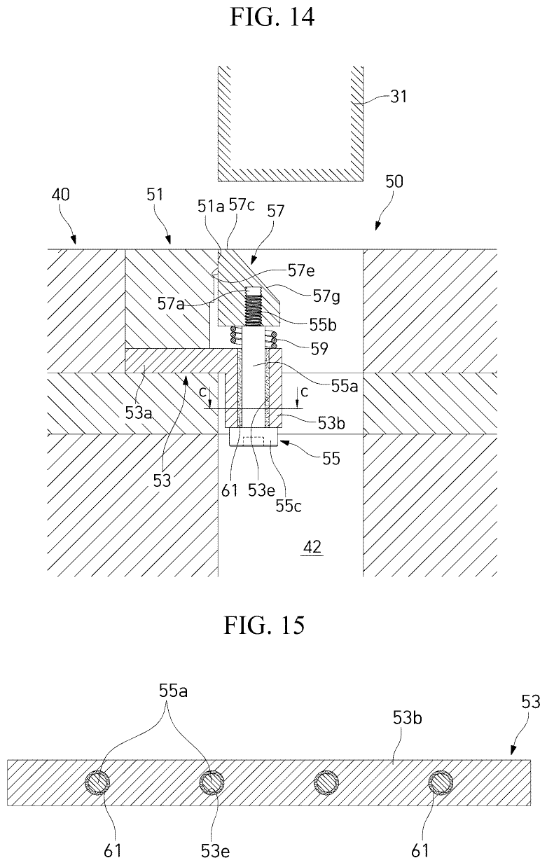

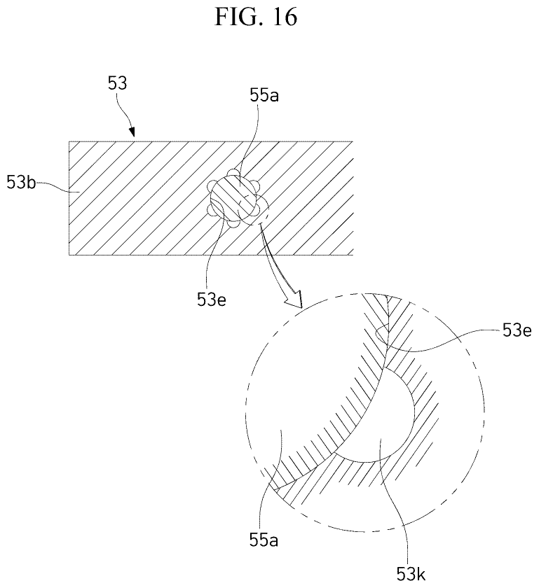

FIG. 14 shows a modification of the electrode plate knockout device 50 according to embodiments of the present disclosure and FIG. 15 is a cross-sectional view along line C-C of FIG. 14 according to embodiments of the present disclosure.

A liner 61 is mounted inside the vertical extension hole 53e. The liner 61 may be a tube-shaped member that is closely fixed to an inner circumferential surface of the vertical extension hole 53e. The liner 61 may prevent wear of the vertical shaft part 55a. The liner 61 may include Teflon, acetal, or any type of engineering plastic. As the liner 61 is applied, wear of the guide body 53 and the guide bolt 55 may be prevented, which may be advantageous for maintenance.

FIG. 16 is a partial cross-sectional view showing a modification of the guide body 53 shown in FIG. 9 according to embodiments of the present disclosure.

A plurality of heat dissipation passages 53k may be formed on the inner circumferential surface of the vertical extension hole 53e. The heat dissipation passage 53k may be formed when the vertical extension hole 53e is machined. The heat dissipation passage 53k may discharge frictional heat generated by the continuous vertical movement of the vertical shaft part 55a to the outside. As long as the frictional heat may be discharged, a shape of the heat dissipation passage 53k may be changed.

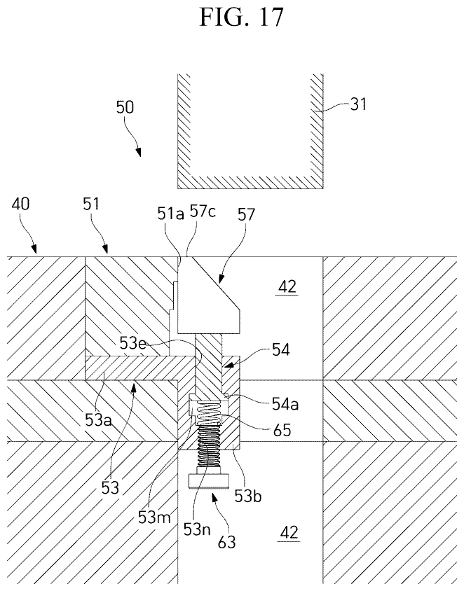

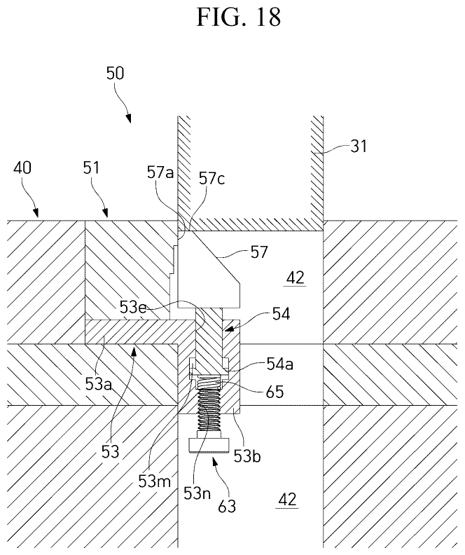

FIGS. 17 and 18 show a modification of the electrode plate knockout device 50 according to embodiments of the present disclosure.

The vertical extension hole 53e, a restriction space 53m, and a female screw hole 53n may be formed in the block support part 53b of the guide body 53. The vertical extension hole 53e, the restriction space 53m, and the female screw hole 53n are arranged in line along a vertical line.

The vertical extension hole 53e is a passage that is vertically open and has a predetermined inner diameter. A lower portion of the vertical extension hole 53e may be open to face the restriction space 53m. The restriction space 53m may be a space that accommodates a lower catching part 54a to vertically move. The restriction space 53m may be a space part having an inner diameter greater than an inner diameter of the vertical extension hole 53e. The female screw hole 53n may be connected to the restriction space 53m, may be a passage that opens on the lower side, and may have a female screw thread on an inner circumferential surface thereof.

A lifting rod 54, a rod spring 65, and a support bolt 63 may be mounted on the block support part 53b.

The lifting rod 54 may be a round rod-shaped member having a predetermined diameter and may have a lower catching part 54a at a lower end thereof. The lower catching part 54a may be a protrusion accommodated in the restricting space 53m to vertically move. An upper end of the lifting rod 54 may be coupled to the bottom surface of the knockout block 57. The coupling of the lifting rod 54 to the knockout block 57 may be performed via a screw.

The support bolt 63 is a member coupled to the female screw hole 53n. A height of an upper end of the support bolt 63 may vary depending on the degree of screw coupling of the support bolt 63 to the female screw hole 53n.

The rod spring 65 may be installed between the support bolt 63 and the lifting rod 54 and elastically support the lifting rod 54. The knockout block 57 is elastically supported by the rod spring 65 upward. A function of the rod spring 65 may be substantially the same as a function of the block support spring 59. As illustrated in FIG. 18, the rod spring 65 is compressed when the punch 31 is lowered and the knockout block 57 is pushed downward. When the punch 31 is raised, the lifting rod 54 is pushed upward, and thus the knockout block 57 is maintained in the standby state shown in FIG. 17.

In an embodiment, an upward pressing force of the knockout block 57 may be adjusted by adjusting the degree of screw coupling of the support bolt 63 to the block support part 53b. In an embodiment, the support bolt 63 may be raised, and the rod spring 65 may be compressed further, providing an increased elastic support force to the knockout block 57. In contrast, when the support bolt 63 is lowered, the rod ring 65 may be expanded, and an upward elastic support force applied to the knockout block 57 may be reduced.

Advantageously, when the electrode plate is punched, the coated part of the electrode plate may be held and compressed, the shear support force of the base part may be improved, punching defects may not occur, and accurate dimensions may be provided.

The punch and die apparatus for manufacturing a secondary battery and an electrode plate knockout device according to the present disclosure provide accurate dimensions without causing punching defects by improving a shear support force of a base part by holding and compressing a coated part of an electrode plate when the electrode plate is punched.

Although the present disclosure has been described above with respect to embodiments thereof and the accompanying drawings, the present disclosure is not limited thereto. Various modifications and variations can be made thereto by those skilled in the art within the spirit of the present disclosure.

What is claimed is:

1. An apparatus, comprising:
a lower die configured to support an electrode plate, the lower die comprising a scrap discharge hole;
an upper die positioned above the lower die, and the upper die comprising a punch corresponding to the scrap discharge hole; and
a knockout device comprising:
a guide body partially protruding toward the scrap discharge hole and configured to provide a support force upon being fixed to the lower die;
a knockout block supported by the guide body, the knockout block configured to vertically move and configured to support the electrode plate via a reaction force corresponding to a downward pressure of the punch to a bottom surface of the electrode plate upon the punch punching the electrode plate; and
an elastic force providing part configured to elastically support the knockout block.

2. The apparatus as claimed in claim 1, wherein the guide body comprises:
a die fixing part mounted on the lower die; and
a block support part formed as a single component with the die fixing part, the block support part located inside the scrap discharge hole and configured to support the knockout block.

3. The apparatus as claimed in claim 1, wherein the electrode plate comprises a coated part in which a substrate is coated with an active material and an uncoated part in which the substrate is exposed,
wherein the knockout block comprises an electrode plate support part configured to be in contact with a bottom surface of the coated part and configured to apply the reaction force to the coated part.

4. The apparatus as claimed in claim 3, wherein the knockout block further comprises a slider part configured to slide while in contact with an inner wall surface of the scrap discharge hole.

5. The apparatus as claimed in claim 2, wherein the knockout block is located above the block support part, and
wherein the elastic force providing part comprises a block support spring located between the block support part and the knockout block.

6. The apparatus as claimed in claim 5, wherein the block support part comprises a vertical extension hole vertically passing through the block support part, and
wherein the apparatus further comprises a vertical movement guide part configured to be coupled to the knockout block upon passing through the vertical extension hole and configured to guide a vertical movement of the knockout block.

7. The apparatus as claimed in claim 6, wherein the vertical movement guide part is a guide bolt passing upward through the vertical extension hole, and wherein an upper end of the guide bolt is coupled to the knockout block.

8. The apparatus as claimed in claim 7, further comprising a liner fixed to an inner circumferential surface of the vertical extension hole.

9. The apparatus as claimed in claim 7, wherein an inner circumferential surface of the vertical extension hole comprises a heat dissipation passage.

10. The apparatus as claimed in claim 2, further comprising:
a vertical extension hole;
a restriction space located under the vertical extension hole, and
a female screw hole located under the restriction space,
wherein the vertical extension hole, the restriction space, and the female screw hold are positioned along a vertical line in the block support part, and
wherein the block support part comprises:
a lifting rod having a lower end fitted into the restriction space and an upper end coupled to the knockout block, the lifting rod configured to be vertically movable;
a support bolt coupled to the female screw hole; and
a rod spring located between the support bolt and the lifting rod, the rod spring configured to elastically support the lifting rod are included in the block support part.

11. An electrode plate knockout device for an apparatus comprising a lower die and an upper die, the lower die configured to support an electrode plate, the lower die comprising a scrap discharge hole, the upper die positioned above the lower die, and the upper die comprising a punch corresponding to the scrap discharge hole, the electrode plate knockout device comprising:
a guide body partially protruding toward the scrap discharge hole and configured to provide a support force upon being fixed to the lower die;
a knockout block supported by the guide body, the knockout block configured to vertically move and configured to support the electrode plate via a reaction force corresponding to a downward pressure of the punch to a bottom surface of the electrode plate upon the punch punching the electrode plate; and
an elastic force providing part configured to elastically support the knockout block.

12. The electrode plate knockout device as claimed in claim 11, wherein the guide body comprises:
a die fixing part mounted on the lower die; and
a block support part formed as a single component with the die fixing part, the block support part located inside the scrap discharge hole and configured to support the knockout block.

13. The electrode plate knockout device as claimed in claim 11, wherein the electrode plate comprises a coated part in which a substrate is coated with an active material and an uncoated part in which the substrate is exposed,
wherein the knockout block comprises an electrode plate support part configured to be in contact with a bottom surface of the coated part and configured to apply the reaction force to the coated part.

14. The electrode plate knockout device as claimed in claim 13, wherein the knockout block further comprises a slider part configured to slide while in contact with an inner wall surface of the scrap discharge hole.

15. The electrode plate knockout device as claimed in claim 12, wherein the knockout block is located above the block support part, and
wherein the elastic force providing part comprises a block support spring located between the block support part and the knockout block.

16. The electrode plate knockout device as claimed in claim 15, wherein the block support part comprises a vertical extension hole vertically passing through the block support part, and
wherein the electrode plate knockout device further comprises a vertical movement guide part configured to be coupled to the knockout block upon passing through the vertical extension hole and configured to guide a vertical movement of the knockout block.

17. The electrode plate knockout device as claimed in claim 16, wherein the vertical movement guide part is a guide bolt passing upward through the vertical extension hole, and wherein an upper end of the guide bolt is coupled to the knockout block.

18. The electrode plate knockout device as claimed in claim 17, further comprising a liner fixed to an inner circumferential surface of the vertical extension hole.

19. The electrode plate knockout device as claimed in claim 17, wherein an inner circumferential surface of the vertical extension hole comprises a heat dissipation passage.

20. The electrode plate knockout device as claimed in claim 12, further comprising:
a vertical extension hole;
a restriction space located under the vertical extension hole', and
a female screw hole located under the restriction space,
wherein the vertical extension hole, the restriction space, and the female screw hold are positioned along a vertical line in the block support part, and
wherein the block support part comprises:
a lifting rod having a lower end fitted into the restriction space and an upper end coupled to the knockout block, the lifting rod configured to be vertically movable;
a support bolt coupled to the female screw hole; and
a rod spring located between the support bolt and the lifting rod, the rod spring configured to elastically support the lifting rod are included in the block support part.
